(19) United States
(12) Patent Application Publication
(10) Pub. No.: US 2026/0043762 A1
(43) Pub. Date: Feb. 12, 2026

(54) DEVICE AND METHOD FOR MEASURING THE THERMAL CONDUCTIVITY OF A TEST OBJECT

(71) Applicant: SEW-EURODRIVE GMBH & CO. KG, Bruchsal (DE)

(72) Inventor: Marc HAMMER, Bruchsal (DE)

(73) Assignee: SEW-EURODRIVE GMBH & CO. KG, Bruchsal (DE)

(21) Appl. No.: 19/099,057

(22) PCT Filed: Jul. 4, 2023
(86) PCT No.: PCT/EP2023/068380

§ 371 Date: Jan. 28, 2025

(30) Foreign Application Priority Data
Aug. 3, 2022 (DE) 102022002808.5

(51) Int. Cl. G01N 25/18

(52) U.S. Cl. CPC G01N 25/18

(57) ABSTRACT

A device for measuring a thermal conductivity of a test object includes a first testing body, which has a first main surface and an opposite first end surface, a second testing body, which has a second main surface and an opposite second end surface, a heat source, which is disposed on the first main surface of the first testing body, at least one first temperature sensor for measuring a first temperature of the first testing body, and at least one second temperature sensor for measuring a second temperature of the second testing body. The testing bodies are arranged such that the test object can be positioned between the end surfaces of the testing bodies, and the first testing body and the second testing body are made of silicon.

### FIELD OF THE INVENTION

The present invention relates to a device for measuring a thermal conductivity of a test object, e.g., which the device includes a first testing body, a second testing body, a heat source, at least one first temperature sensor for measuring a first temperature of the first testing body, and at least one second temperature sensor for measuring a second temperature of the second testing body. The present invention also relates to a method for measuring a thermal conductivity of a test object, e.g., via a device described herein.

### BACKGROUND INFORMATION

In certain conventional systems, to dissipate heat, for example, from an electronic circuit on a circuit board, cooling bodies are connected to the circuit board via a film, paste, or in another form of material. The material may also electrically insulate the cooling body from the circuit board. A suitable material, referred to as “thermal interface material”, fills air pockets between two surfaces, which air pockets are inevitably caused by surface roughnesses. This improves the heat transfer between the surfaces, as the thermal conductivity of the filled-up air pockets is significantly increased. Thermal interface material is also used to compensate for tolerances while maintaining sufficient thermal conductivity.

To measure the thermal conductivity, or the thermal resistance, of a test object made of a thermal interface material, the stationary cylinder method according to ASTM D5470 is often used. The test object is clamped between two plane-parallel cylinders and subjected to a heat flux, which allows conclusions to be drawn about the thermal conductivity, or, for example, the thermal resistance of the test object. The test object can be tested with a constant contact pressure and variable thickness or with a variable contact pressure and constant thickness.

A device and a method for measuring the thermal conductivity of a measured object are described in German Patent Document No. 11 2016 004 973. The measured object is clamped between two holding elements. A heating element rests against one holding element and a cooling element is in contact with the other holding element.

A device and a method for measuring the thermal conductivity of a sample are described in PCT Patent Document No. WO 2019/145549. The device includes a temperature sensor arrangement with several temperature sensors for determining temperature measurement values at several points.

The cylinders usually consist of aluminum alloys with relatively high thermal conductivity, for example, EN AW 6060 or EN AW 6063. In order to determine the heat flux through the test object as accurately as possible, a temperature measurement is carried out in the cylinders. This also requires precise knowledge of the thermal conductivity of the cylinders.

The problem resulting from this is that aluminum alloys do not always have the same composition. Manufacture is subject to tolerances in the composition, which means that each batch has deviations in the material properties. Thus, different cylinders usually have thermal conductivities that differ from one another. Thus, measurements with different cylinders usually provide different results for the thermal conductivity of the test object.

### SUMMARY

Example embodiments of the present invention provide a device and a method for measuring the thermal conductivity of a test object.

A device for measuring a thermal conductivity of a test object includes a first testing body, which has a first main surface and an opposite first end surface, a second testing body, which has a second main surface and an opposite second end surface, a heat source, which is disposed on the first main surface of the first testing body, at least one first temperature sensor for measuring a first temperature of the first testing body, and at least one second temperature sensor for measuring a second temperature of the second testing body. The testing bodies are arranged such that the test object can be positioned between the end surfaces of the testing bodies. The first testing body and the second testing body are made of silicon.

Silicon has a relatively high thermal conductivity and is thus suitable for carrying out thermal conductivity measurements. Industrially, wafers are produced from silicon for the manufacture of electronic components. Wafers are disks that are cut from monocrystalline silicon in the shape of a cylinder. Since such methods are used in series production, blanks for manufacturing wafers can be purchased inexpensively and used as testing bodies. Due to the high purity of the silicon, the thermal conductivity of the testing bodies is constant; there is very little deviation of the material data, e.g., the thermal conductivity. Thus, the problem of deviations in the thermal material properties of the testing bodies when using aluminum alloys in the test setup can be eliminated.

According to example embodiments, the device further includes a heat sink disposed on the second main surface of the second testing body. The heat sink allows a more accurate capture of a heat flux flowing through the first testing body, the test object, and the second testing body when measuring the thermal conductivity of the test object.

According to example embodiments, the heat sink is formed as a Peltier element. For example, a hot side of the Peltier element faces away from the end surfaces of the testing bodies, and a cold side of the Peltier element faces the end surfaces of the testing bodies. When a current flows through the Peltier element, the cold side of the Peltier element is cooled.

According to example embodiments, the first testing body and the second testing body are each formed cylindrically, e.g., circular-cylindrically, and the main surfaces of the testing bodies extend parallel to the end surfaces of the testing bodies. Testing bodies formed in this manner are relatively readily available as blanks, e.g., as monocrystalline blanks, for the manufacture of wafers.

According to example embodiments, the first testing body and the second testing body are respectively made of monocrystalline silicon. As a result, the thermal conductivity of the testing bodies is particularly constant and deviations of the material data, e.g., the thermal conductivity, are further reduced.

According to example embodiments, at least one first temperature sensor is disposed on the first end surface of the first testing body. According to example embodiments, at least one second temperature sensor is disposed on the second end surface of the second testing body. The temperature sensors are thus in direct contact with the surfaces of the test object.

According to example embodiments, at least one first temperature sensor is disposed within the first testing body, at a distance from the first end surface and at a distance from the first main surface. According to example embodiments, at least one second temperature sensor is disposed within the second testing body, at a distance from the second end surface and at a distance from the second main surface.

According to example embodiments, the at least one first temperature sensor is formed as a discrete component. According to example embodiments, the at least one second temperature sensor is formed as a discrete component. Such temperature sensors are referred to, for example, as measuring resistors, such as a PT100 resistor, whose ohmic resistance is temperature-dependent. The relationship between the ohmic resistance and the temperature is, for example, linear.

According to example embodiments, the at least one first temperature sensor is formed as a doping of the first testing body. According to example embodiments, the at least one second temperature sensor is formed as a doping of the second testing body. Using silicon as the material for the testing bodies allows the integration of additional functions, such as a temperature measurement, through the targeted introduction of dopants. The temperature sensors are thus integrated into the testing bodies. Depending on the type of doping, the relationship between the ohmic resistance of the doping and the temperature is linear or non-linear.

According to example embodiments, the heat source is formed as a doping of the first testing body. Using silicon as the material for the testing bodies allows the integration of additional features, such as heat generation, through the targeted introduction of dopants. The heat source is thus integrated into the first testing body. A current flowing through the doping creates a voltage drop in the doping, whereby heat is generated in the doping.

According to example embodiments, the heat source is formed as a Peltier element. For example, a hot side of the Peltier element faces the end surfaces of the testing bodies, and a cold side of the Peltier element faces away from the end surfaces of the testing bodies. When a current flows through the Peltier element, the hot side of the Peltier element is heated.

When carrying out a method described herein for measuring a thermal conductivity of a test object via a device described herein, the test object is first positioned between the end surfaces of the testing bodies. Via the heat source, thermal energy is introduced into the device via the first main surface of the first testing body. Via the at least one first temperature sensor, at least one first temperature of the first testing body is measured. Via the at least one second temperature sensor, at least one second temperature of the second testing body is measured. The thermal conductivity of the test object is calculated from the thermal energy introduced, the at least one first temperature, and the at least one second temperature.

For example, the test object is a film, paste, or other form of material that constitutes a “thermal interface material”. Such a material is relatively soft and compressible. When measuring the thermal conductivity of the test object, a contact pressure acts on the test object, which causes the test object to undergo deformation. As a result, the test object is clamped between the first testing body and the second testing body, e.g., held in a force-fit manner. The method allows a relatively accurate and reproducible measuring of the thermal conductivity of the test object. For example, the result of the measuring is only insignificantly dependent on the testing bodies used. The use of a structurally identical device with other testing bodies made of silicon provides the same results.

Further features and aspects of example embodiments of the present invention are explained in more detail below with reference to the appended schematic Figure.

### BRIEF DESCRIPTION OF THE DRAWING

FIG. 1 is a schematic view of a device for measuring the thermal conductivity of a test object.

### DETAILED DESCRIPTION

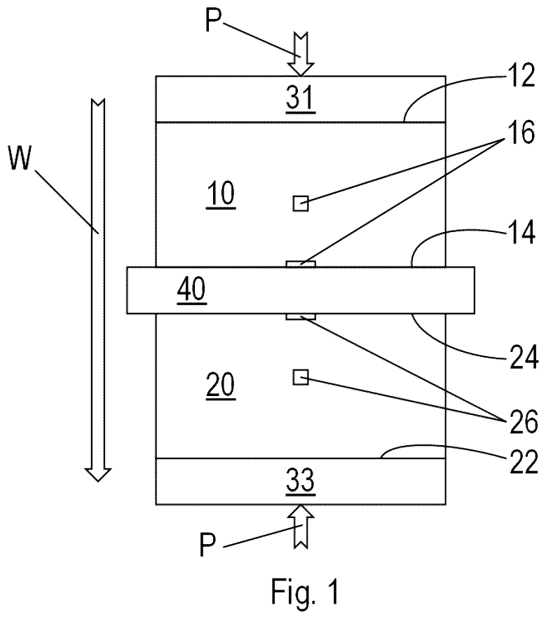

FIG. 1 is a schematic view of a device for measuring the thermal conductivity of a test object 40. The device includes a first testing body 10 and a second testing body 20. The first testing body 10 and the second testing body 20 are respectively made of silicon. For example, the first testing body 10 and the second testing body 20 are respectively made of monocrystalline silicon.

The first testing body 10 is formed cylindrically, e.g., circular-cylindrically, and has a first main surface 12 and a first end surface 14 opposite the first main surface 12. The first main surface 12 of the first testing body 10 extends parallel to the first end surface 14 of the first testing body 10.

The second testing body 20 is formed cylindrically, e.g., circular-cylindrically, and has a second main surface 22 and a second end surface 24 opposite the second main surface 22. The second main surface 22 of the second testing body 20 extends parallel to the second end surface 24 of the second testing body 20.

The test object 40 is positioned between the first testing body 10 and the second testing body 20. The test object 40 is a film, paste, or other form of material that acts as a “thermal interface material”. As illustrated, the test object 40 projects slightly laterally beyond the testing bodies 10, 20. The test object 40 should not significantly exceed the diameter of the testing bodies 10, 20, as otherwise undesirable heat losses to the outside will be increased.

The testing bodies 10, 20 are arranged such that the first end surface 14 of the first testing body 10 is opposite the second end surface 24 of the second testing body 20. The first end surface 14 extends parallel to the second end surface 24. The test object 40 is positioned between the first end surface 14 and the second end surface 24. The test object 40 thus rests directly against the first end surface 14 and the second end surface 24.

The device includes a heat source 31. The heat source 31 is disposed on the first main surface 12 of the first testing body 10. The heat source 31 is formed, for example, in the form of an insulated heating coil which rests against the first main surface 12 or is mechanically connected, e.g., bonded, to the first main surface 12. Alternatively, the heat source 31 is formed as a doping of the first testing body 10. Thus, the heat source 31 is integrated into the first testing body 10 in the form of a doping.

The device includes a heat sink 33. The heat sink 33 is disposed on the second main surface 22 of the second testing body 20. The heat sink 33 is formed, for example, in the form of a heat sink which rests against the second main surface 22 or is mechanically connected, e.g., bonded, to the second main surface 22. The heat sink 33 is, for example, liquid-cooled.

For example, the device includes two first temperature sensors 16. The first temperature sensors 16 respectively serve to measure a first temperature of the first testing body 10. Each of the first temperature sensors 16 measures the first temperature at a different point on the first testing body 10.

For example, one of the first temperature sensors 16 is disposed on the first end surface 14 of the first testing body 10. This first temperature sensor 16 is thus in direct contact with a surface of the test object 40. It is also possible to insert several PT100 temperature sensors radially through bores as close as possible to the first end surface 14.

For example, one of the first temperature sensors 16 is also disposed within the first testing body 10. This first temperature sensor 16 is thus disposed at a distance from the first end surface 14 and at a distance from the first main surface 12.

For example, one of the first temperature sensors 16 is formed as a discrete component. For example, this first temperature sensor 16 is formed in the form of a measuring resistor whose ohmic resistance is temperature-dependent.

For example, one of the first temperature sensors 16 is also formed as a doping of the first testing body 10. Thus, this first temperature sensor 16 is integrated into the first testing body 10 in the form of a doping.

For example, the device includes two second temperature sensors 26. The second temperature sensors 26 are each used to measure a second temperature of the second testing body 20. Each of the second temperature sensors 26 measures the second temperature at a different point on the second testing body 20.

For example, one of the second temperature sensors 26 is disposed on the second end surface 24 of the second testing body 20. This second temperature sensor 26 is thus in direct contact with a surface of the test object 40.

For example, one of the second temperature sensors 26 is also disposed within the second testing body 20. This second temperature sensor 26 is thus disposed at a distance from the second end surface 24 and at a distance from the second main surface 22.

For example, one of the second temperature sensors 26 is formed as a discrete component. For example, this second temperature sensor 16 is formed in the form of a measuring resistor whose ohmic resistance is temperature-dependent.

For example, one of the second temperature sensors 26 is also formed as a doping of the second testing body 20. Thus, this second temperature sensor 26 is integrated into the second testing body 20 in the form of a doping.

To measure the thermal conductivity of the test object 40 via the device, the test object 40 is first positioned between the end surfaces 14, 24 of the testing bodies 10, 20, as illustrated in FIG. 1.

A force is exerted on the heat source 31 or directly on the first main surface 12 of the first testing body 10 in the direction of the test object 40. Similarly, a force is exerted on the heat sink 33 or directly on the second main surface 22 of the second testing body 20 in the direction of the test object 40. These forces respectively cause a contact pressure P acting on the test object 40. The test object 40 is thus clamped between the first testing body 10 and the second testing body 20, e.g., held in a force-fit manner.

It is possible to exert a constant contact pressure P on the test object 40. For example, the test object 40 is deformed differently depending on the amount of contact pressure P, i.e., it has a thickness that depends on the contact pressure P. The thickness of the test object 40 corresponds to a distance between the first end surface 14 and the second end surface 24.

It is also possible to keep the thickness of the test object 40 constant by specifying the distance between the first end surface 14 and the second end surface 24. For example, the amount of contact pressure P is variable and depends on the specified thickness of the test object 40.

Via the heat source 31, thermal energy is introduced into the device via the first main surface 12 of the first testing body 10. The thermal energy introduced causes a heat flux W, which flows through the first testing body 10, the test object 40, and the second testing body 20 towards the heat sink 33 on the second main surface 22 of the second testing body 20.

Via the first temperature sensors 16, first temperatures of the first testing body 10 are measured at several points of the first testing body 10. Via the second temperature sensors 26, second temperatures of the second testing body 20 are measured at several points of the second testing body 20.

The thermal conductivity of the test object 40 is calculated from the thermal energy introduced, the measured first temperatures, and the measured second temperatures.

The calculation of the thermal conductivity of the test object 40 also includes other variables, for example, the arrangement of the temperature sensors 16, 26 in the testing bodies 10, 20, as well as the thermal conductivity of the testing bodies 10, 20. However, these respectively are constant values that are already known before the measurement begins.

### LIST OF REFERENCE CHARACTERS

10 First testing body
12 First main surface
14 First end surface
16 First temperature sensor
20 Second testing body
22 Second main surface
24 Second end surface
26 Second temperature sensor
31 Heat source
33 Heat sink
40 Test object
W Heat flux
P Contact pressure

1-12. (canceled)

13. A device for measuring thermal conductivity of a test object, comprising:
a first test body including a first main surface and an opposite first end surface;
a second test body including a second main surface and an opposite second end surface;
a heat source arranged on the first main surface of the first test body;
at least one first temperature sensor adapted to measure a first temperature of the first test body; and
at least one second temperature sensor adapted to measure a second temperature of the second test body;
wherein the test object is adapted to be positioned between the first end surface and the second end surface; and
the first test body and the second test body are made of silicon.

14. The device according to claim 13, further comprising a heat sink arranged on the second main surface of the second test body.

15. The device according to claim 14, wherein the heat sink includes a Peltier element having a hot side facing away from the end surfaces of the test bodies and a cold side facing the end surfaces of the test bodies.

16. The device according to claim 13, wherein the first test body and the second test body are cylindrical, and the main surfaces of the test bodies extend parallel to the end surfaces of the test bodies.

17. The device according to claim 13, wherein the test bodies are formed of monocrystalline silicon.

18. The device according to claim 13, wherein at least one first temperature sensor is arranged on the first end surface of the first test body, and/or at least one second temperature sensor is arranged on the second end surface of the second test body.

19. The device according to claim 13, wherein at least one first temperature sensor is arranged within the first test body, at a distance from the first end surface and at a distance from the first main surface, and/or at least one second temperature sensor is arranged within the second test body, at a distance from the second end surface and at a distance from the second main surface.

20. The device according to claim 13, wherein at least one first temperature sensor is arranged on the first end surface of the first test body, and at least one second temperature sensor is arranged on the second end surface of the second test body.

21. The device according to claim 13, wherein at least one first temperature sensor is arranged within the first test body, at a distance from the first end surface and at a distance from the first main surface, and at least one second temperature sensor is arranged within the second test body, at a distance from the second end surface and at a distance from the second main surface.

22. The device according to claim 13, wherein the first temperature sensor is arranged as a discrete component, and/or the second temperature sensor is arranged as a discrete component.

23. The device according to claim 13, wherein the first temperature sensor is arranged as a discrete component, and the second temperature sensor is arranged as a discrete component.

24. The device according to claim 13, wherein the first temperature sensor includes a doping of the first test body, and/or the second temperature sensor includes a doping of the second test body.

25. The device according to claim 13, wherein the first temperature sensor includes a doping of the first test body, and the second temperature sensor includes a doping of the second test body.

26. The device according to claim 13, wherein the heat source includes a doping of the first test body.

27. The device according to claim 13, wherein the heat source includes a Peltier element having a hot side facing the end surfaces of the test bodies and a cold side facing away from the end surfaces of the test bodies.

28. The device according to claim 13, wherein the first test body and the second test body are circular cylindrical.

29. The device according to claim 13, wherein the test object includes a film, a paste, and/or a thermal interface material.

30. The device according to claim 13, wherein the first end surface is parallel to the second end surface.

31. The device according to claim 13, wherein the test object rests directly against the first end surface and the second end surface.

32. The device according to claim 13, wherein the heat source includes an insulated heating coil.

33. A method for measuring thermal conductivity of a test object with a device as recited in claim 13, comprising:
positioning the test object between the end surfaces of the test bodies;
introducing, via the heat source, thermal energy into the device via the first main surface of the first test body;
measuring, by the first temperature sensor, at least a first temperature of the first test body;
measuring, by the second temperature sensor, at least one second temperature of the second test body; and
determining the thermal conductivity of the test object from the thermal energy introduced, the first temperature, and the second temperature.
